(19) United States
(12) Patent Application Publication
(10) Pub. No.: US 2026/0155664 A1
(43) Pub. Date: Jun. 4, 2026

(54) BATTERY CHARGER RELEASE APPARATUSES AND METHODS OF USING THE SAME

(71) Applicant: Vishaal Boehm Verma, Crystal Lake, IL (US)

(72) Inventor: Vishaal Boehm Verma, Crystal Lake, IL (US)

(21) Appl. No.: 19/406,552

(22) Filed: Dec. 2, 2025

Related U.S. Application Data
(60) Provisional application No. 63/727,352, filed on Dec. 3, 2024.

(51) Int. Cl. H02J 7/00

(52) U.S. Cl. CPC H02J 7/751

(57) ABSTRACT

Battery release mechanisms on battery chargers allow batteries to be more easily released from the battery chargers. The battery release mechanisms provide a user input element on the battery charger for pulling, pushing, twisting, squeezing, or otherwise manipulating the same which causes a battery to be released from the battery charger. Methods of using the same are further provided.

### CROSS-REFERENCE TO RELATED APPLICATIONS

The present invention claims priority to U.S. Provisional Patent App. No. 63/727,352, titled “Release Mechanism for Battery Charger,” filed Dec. 3, 2024, which is incorporated herein by reference in its entirety.

### TECHNICAL FIELD

The present invention belongs to the field of rechargeable batteries and battery chargers. Specifically, the present invention provides a battery release mechanism on a battery charger, allowing the battery to be more easily released from a battery charger. The battery release mechanisms provide a contact element on the battery charger for pulling, pushing, twisting, squeezing, or otherwise manipulating the same which causes a battery to be released from the battery charger. Methods of using the same are further provided.

### BACKGROUND

Rechargeable batteries require a battery charger for recharging the same. Generally, a battery charger has leads or contacts that engage the positive and negative leads or contacts of the battery to ensure that the battery is charged properly. The battery chargers are typically sized and shaped in such a way to ensure that the battery fully engages the leads or contacts so that the batteries charge without fail.

More and more power tools, for example, are powered by rechargeable batteries, typically in the form of a rechargeable battery pack that is shaped and sized both to fit snugly into the power tool itself for powering the same and into the battery charger. To ensure that the battery packs contact the leads or contacts each and every time, the battery packs often include rigid structure that mates with rigid structure on the battery chargers, typically in a male/female mating relationship. For example, with respect to power tool battery packs, the battery packs tend to be in the shape of blocks with rails for engaging or mating with slots or other engagement elements or surfaces on the battery charger. When the rails of a battery, for example, are pushed into or through the slots of the battery charger, electrical contacts on the battery may be guided to mating electrical contacts on the battery charger, which, when pressed together, may cause the electrical contacts on the battery to frictionally engage the electrical contacts of the battery charger, often in a male/female mating relationship. The frictional engagement of the respective electrical contacts of the battery and the battery charger often makes it difficult to separate.

Specifically, when the battery, for example, is frictionally held on the battery charger, it often takes two hands for a user to remove the battery from the battery charger. Often, one hand is used to hold down the battery charger while the other hand grips the battery and pulls the same out of the battery charger slots, thereby disengaging the frictionally held electrical contacts of the battery and the battery charger. Even with this arrangement of holding the battery charger with one hand and pulling the battery therefrom with the other, it may still be difficult to overcome the friction necessary to easily remove the battery for use.

A need, therefore, exists for battery chargers having release mechanisms. Specifically, a need exists for battery chargers having release mechanisms that allow a user to easily release a battery from a battery charger. More specifically, a need exists for battery chargers that accept, for example, power tool batteries, to more easily allow for the removal of the batteries from the battery chargers.

In addition, a need exists for battery chargers having release mechanisms that allow a user to easily remove batteries therefrom using one hand. Specifically, a need exists for battery chargers having release mechanisms that provide a simple push, pull, twist, or other like motion to release the batteries from the battery chargers. More specifically, a need exists for battery chargers having relatively simple mechanisms for providing users with the ability to easily release the batteries therefrom.

### SUMMARY OF THE INVENTION

The present invention provides a battery release mechanism on a battery charger, allowing the battery to be more easily released from a battery charger. The battery release mechanisms provide a contact element on the battery charger for pulling, pushing, twisting, squeezing, or otherwise manipulating the same which causes a battery to be released from the battery charger. Methods of using the same are further provided.

To this end, in an embodiment of the present invention, a battery charger release apparatus is provided. The battery charger release apparatus comprises: a battery charger comprising a battery engagement element configured to engage with and accept a battery for charging the battery when engaged thereto; and a release mechanism on the battery charger, wherein the release mechanism comprises a user input element on a first end of the release mechanism, a battery contacting element configured to contact the battery when the battery is engaged to the battery engagement element, and a coupling linkage between the user input element and the battery contacting element, wherein the coupling linkage is configured to convert movement of the user input element to movement of the battery contacting element thereby releasing the battery from the battery engagement element.

In an embodiment, the release mechanism comprises a lever arm, wherein the user input element is on the first end of the lever arm and the battery contacting element is on a second end of the lever arm, and further wherein the coupling linkage comprises a pivot located between the first end and the second end of the lever arm.

In an embodiment, the user input element comprises a pushing surface on the first end of the lever arm.

In an embodiment, the battery contacting element is configured to engage a mating element on the battery.

In an embodiment, the battery contacting element includes a protuberance.

In an embodiment, the battery engagement element comprises an electrical contact or terminal.

In an embodiment, the battery charger comprises a cavity, wherein the release mechanism is disposed at least partially within the cavity.

In an embodiment, the release mechanism comprises a biasing element for biasing the user input element. In an embodiment, the biasing element is a spring. In an embodiment, the biasing element is configured to bias the user input element in a first direction and bias the battery contacting element in a second direction.

In an embodiment, the user input element comprises a push-button.

In an embodiment, the battery contacting element is configured to push the battery away from the battery engagement element.

In an embodiment, the coupling linkage comprises a plunger extending from the user input element and configured to engage the battery contacting element to cause the battery contacting element to move in a different direction as the plunger.

In an embodiment, the plunger is engaged to the battery contacting element through a pinion gear.

In an embodiment, the plunger comprises a rack having a plurality of teeth and further wherein the rack is engaged with the pinion gear.

In an embodiment, the battery contacting element comprises a rack having a plurality of teeth and further wherein the rack of the pusher is engaged with the pinion gear.

In an embodiment, the plunger comprises a first rack having a plurality of teeth, wherein the battery contacting element comprises a second rack having a plurality of teeth, and further wherein the first rack and the second rack are engaged to the pinion gear such that motion of the plunger in a first direction causes motion of the battery contacting element in a second direction.

In an embodiment, the battery charger release apparatus further comprises a biasing element engaged with the battery contacting element. In an embodiment, the biasing element is a spring. In an embodiment, the biasing element is configured to bias the battery contacting element against the battery when the battery is engaged with the battery engagement element.

In an embodiment, a battery charger release system is provided. The battery charger release system comprises the battery charger release apparatus and a battery.

In an alternate embodiment of the present invention, a method of using a battery charger release system is provided. The method comprises the steps of: providing a battery charger comprising a battery engagement element configured to engage with and accept a battery for charging the battery when engaged thereto and a release mechanism on the battery charger, wherein the release mechanism disengages the battery from the battery charger when manipulated by a user; providing the battery engaged with the battery engagement element of the battery charger; manipulating the release mechanism on the battery charger; and disengaging the battery from the battery engagement element.

In an embodiment, the release mechanism comprises a user input element on a first end of the release mechanism, a battery contacting element configured to contact the battery when the battery is engaged to the battery engagement element, and a coupling linkage between the user input element and the battery contacting element, wherein the coupling linkage is configured to convert movement of the user input element to movement of the battery contacting element thereby releasing the battery from the battery engagement element.

In an embodiment, manipulating the release mechanism on the battery charger comprises pulling, pushing, twisting, or squeezing the release mechanism.

In an embodiment, movement of the release mechanism in a first direction causes the battery to disengage from the battery engagement element.

It is, therefore, an advantage and objective of the present invention to provide battery chargers having release mechanisms.

Specifically, it is an advantage and objective of the present invention to provide battery chargers having release mechanisms that allow a user to easily release a battery from a battery charger.

More specifically, it is an advantage and objective of the present invention to provide battery chargers that accept, for example, power tool batteries, to more easily allow for the removal of the power tool batteries from the power tool battery chargers.

In addition, it is an advantage and objective of the present invention to provide battery chargers having release mechanisms that allow a user to easily remove batteries therefrom using one hand.

Specifically, it is an advantage and objective of the present invention to provide battery chargers having release mechanisms that provide a simple push, pull, twist, squeeze, or other like motion to release the batteries from the battery chargers.

More specifically, it is an advantage and objective of the present invention to provide battery chargers having relatively simple mechanisms for providing users with the ability to easily release the batteries therefrom.

Additional features and advantages of the present invention are described in, and will be apparent from, the detailed description of the presently preferred embodiments and from the drawings.

### BRIEF DESCRIPTION OF THE DRAWINGS

The drawing figures depict one or more implementations in accord with the present concepts, by way of example only, not by way of limitations. In the figures, like reference numerals refer to the same or similar elements.

FIG. 1 illustrates a perspective view of a battery charger with a battery release mechanism in an embodiment of the present invention.

FIG. 2 illustrates a perspective view of a battery charger with a battery engaged therewith with a battery release mechanism in an embodiment of the present invention.

FIG. 3 illustrates a perspective view of a battery charger with a battery engaged therewith wherein the battery is being released by a user via the battery release mechanism in an embodiment of the present invention.

FIG. 4 illustrates a perspective view of a battery charger with a battery disengaging from the battery charger via the battery release mechanism in an embodiment of the present invention.

FIG. 5 illustrates a top view of a battery charger with a battery engaged therewith with a battery release mechanism in an embodiment of the present invention.

FIGS. 6A-6B illustrate cross-sectional views of a battery and battery charger with a battery release mechanism along line VI-VI in an embodiment of the present invention.

FIG. 7 illustrates a perspective view of a battery charger with a battery release mechanism in an alternate embodiment of the present invention.

FIG. 8 illustrates a perspective view of a battery charger with a battery engaged therewith with a battery release mechanism in an alternate embodiment of the present invention.

FIG. 9 illustrates a close-up perspective view of a battery charger engagement slot with battery release mechanism in an alternate embodiment of the present invention.

FIG. 10 illustrates a close-up bottom view of a battery charger engagement slot having a battery engaged therewith in an alternate embodiment of the present invention.

FIG. 11 illustrates a front view of a battery charger with a battery engaged therewith with a battery release mechanism in an embodiment of the present invention.

FIG. 12 illustrates a cross-sectional view of a battery and battery charger with a battery release mechanism along line XII-XII in an embodiment of the present invention.

FIG. 13 illustrates a close-up cross-sectional view of a battery and battery charger with a battery release mechanism along line XII-XII in an embodiment of the present invention.

### DETAILED DESCRIPTION OF THE PRESENTLY PREFERRED EMBODIMENTS

The present invention provides a battery release mechanism on a battery charger, allowing the battery to be more easily released from a battery charger. The battery release mechanisms provide a user contacting element on the battery charger for pulling, pushing, twisting, squeezing, or otherwise manipulating the same which causes a battery to be released from the battery charger. Methods of using the same are further provided.

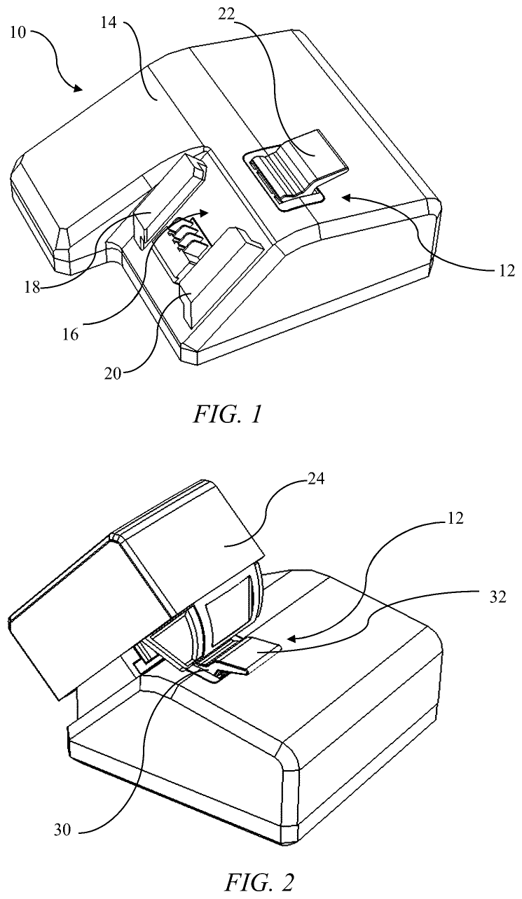

Now referring to the figures, FIG. 1 illustrates a battery charger 10 having a battery release mechanism 12 in an embodiment of the present invention. The battery charger 10 comprises a housing 14 containing electronics and other structural elements allowing it to be used to charge a battery. The battery charger 10 shown in the figures is of a type that is typically used to charge power tool batteries, as described in more detail below with reference to the figures. However, it should be noted that the battery release mechanisms described herein may be utilized for any battery charger that may engage with a rechargeable battery to aid in the removal of the battery from the battery charger.

The battery charger 10 may include a battery receiving slot 16, which may comprise a pair of battery receiving slot arms 18, 20, for engaging with mating surfaces on a rechargeable battery 24. A set of electrical leads or contacts 22 may further be provided for engaging with respective leads or contacts on the battery 24 that may be attached thereto. When a rechargeable battery 24 is slid, pushed, or pressed between the battery receiving slot arms 18, 20, it may be frictionally held therein in position and location whereby the leads or contacts 22 of the battery charger may remain engaged with the respective leads or contacts on the battery 24 disposed thereon. FIG. 2 illustrates battery 24 disposed within the battery receiving slot 16 between the battery receiving slot arms 18, 20, allowing the leads or contacts 18, 20 of the battery charger 10 to contact the leads or contacts on the rechargeable battery 24.

The battery release mechanism 12 may, generally, have a user input element that allows a user to manipulate the same when the user wishes to release the battery 24 from the battery charger 10. Moving the user input element may move a battery contacting element, as described in more detail in the exemplary embodiments below, which may move the battery 24 from the battery charger 10 and thereby release the same. Between the user input element and the battery contacting element may be a coupling linkage that may comprise one or more elements that converts movement of the user input element to movement of the battery contacting element. Thus, a user wishing to release the battery 24 from the battery charger 10 may engage the user input element, such as, for example, by pulling, pushing, twisting, squeezing, or otherwise manipulating the same. It should be noted that the coupling linkage may include any means for converting the movement of the user input element to movement of the battery contacting element, such as through surface-on-surface contact, a cam, a wedge, a gear, such as one or more racks and a pinion gear, a lever, or any other like mechanisms, and is not meant to be limited as described herein.

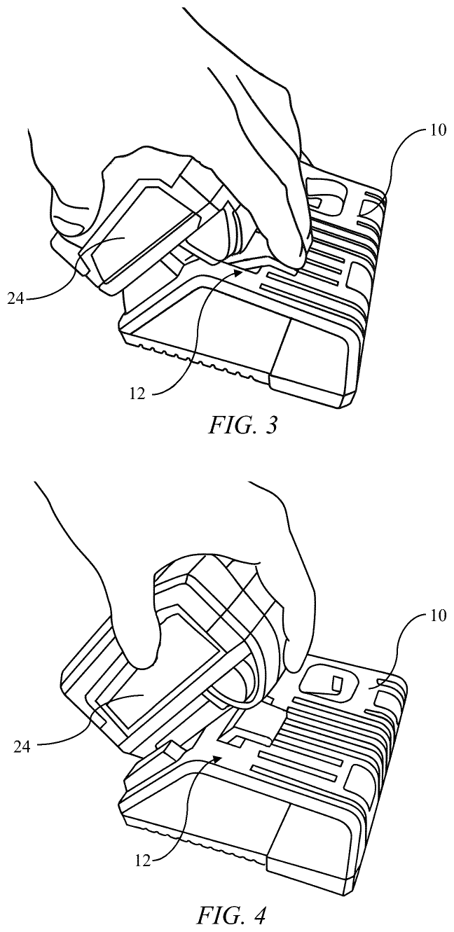

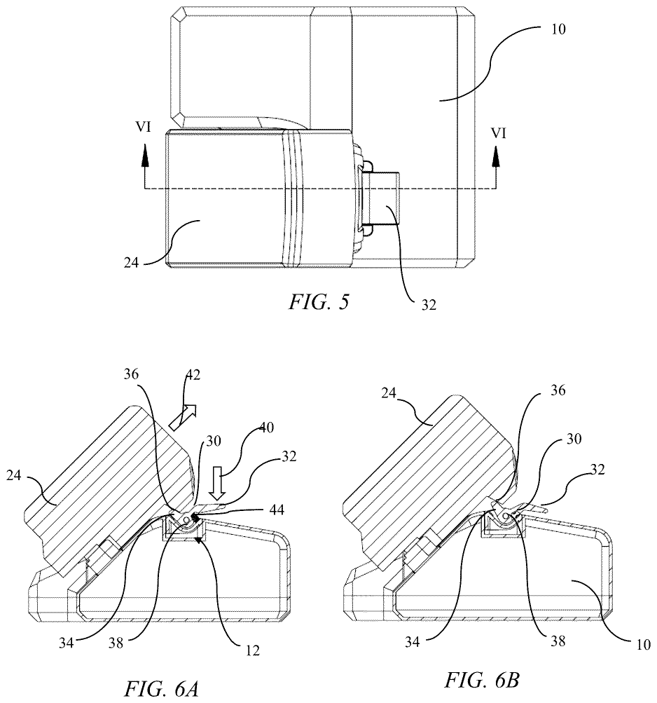

In an exemplary embodiment, the battery release mechanism 12 may comprise a pivoting lever arm 30 having the user input element, shown in the figures as a surface 32 upon which a user may press, as illustrated in FIGS. 3 and 6A. The lever arm 30 may further have a battery contacting element 34, shown in the figures as a contacting tab or protuberance that may contact and/or otherwise engage a mating surface 36 on the battery 24. Disposed between the surface 32 and the battery contacting element 34 may be a coupling linkage that links the surface 32 and the battery contacting element 34, namely a pivot or fulcrum 38 that allows the surface 32 and the battery contacting element 34 to pivot with respect to each other along the pivot or fulcrum 38. Specifically, movement of the surface 32 in a first direction 40 may cause the battery contacting element 34 to move in a second direction 42 through the pivot or fulcrum 38, thereby moving and pushing the battery 24 at least partially out of the battery receiving slot 16 of the battery charger 10. A biasing element, such as a spring 44, may be disposed between the lever arm 30 and the battery charger 10 that may bias the lever arm 30 upwardly or otherwise away from the battery charger 10.

Thus, when the battery 24 is desired by a user to be charged, it may be pushed within the battery receiving slot 16 and the mating surface 36 on the battery may contact or engage the battery contacting element 34, thereby pushing it down. After the battery 24 has charged within the battery charger 10, a user may wish to remove the battery 24 from the battery charger 10. Pressing down on the surface 32, as shown in FIGS. 3 and 6A, may cause the lever arm 30 to pivot along the pivot or fulcrum 38 thereby forcing the battery contacting element 34 upwardly, which may also move the battery 24 upwardly, due to contacting the mating surface 36, at least partially out of the battery receiving slot 16, as illustrated in FIGS. 4 and 6A-6B. The leads or contacts 18, 20 on the battery charger 10 may disengage from the respective leads or contacts on the battery 24. Therefore, the battery 24 may be more easily removed from the battery receiving slot 16. As illustrated in FIGS. 3 and 4, for example, a user may accomplish the removal of the battery 24 from the battery charger 10 with one hand.

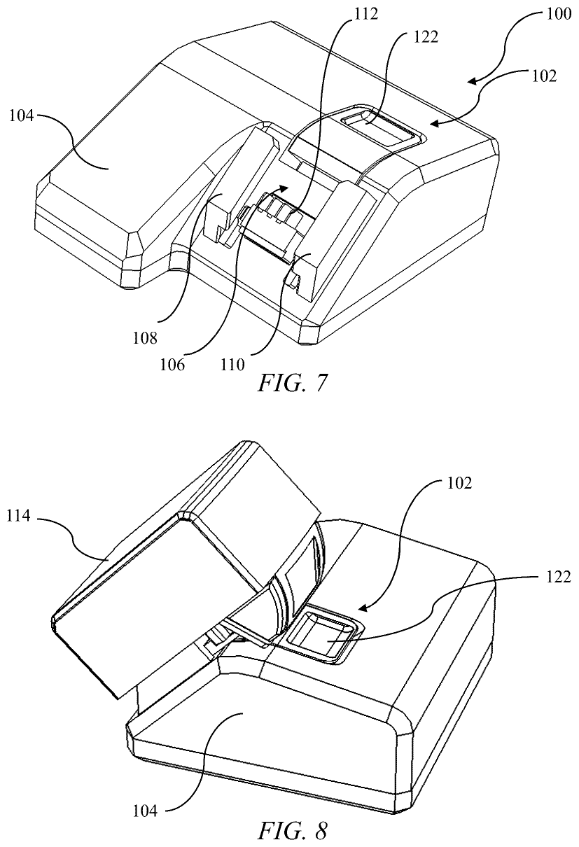

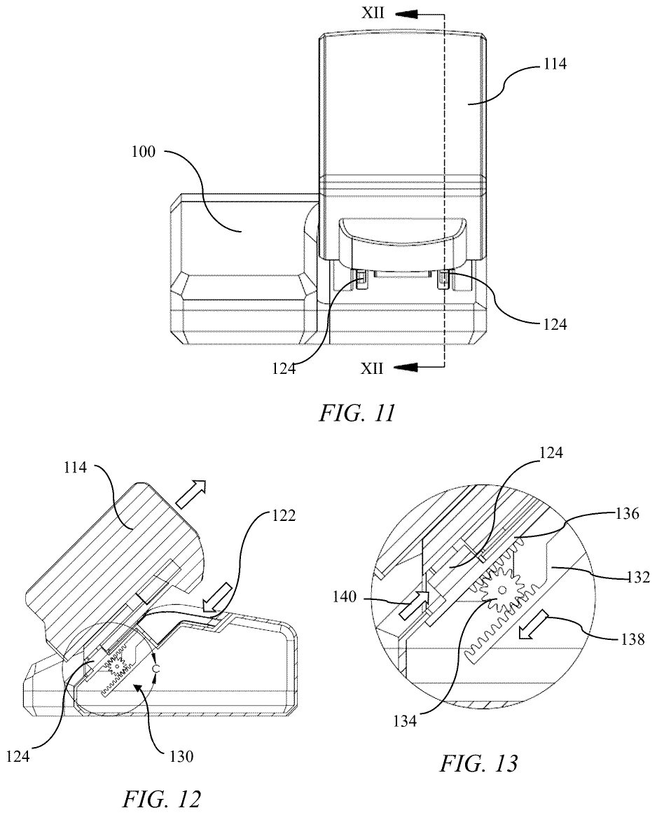

Referring now to FIGS. 7-13, a battery charger 100 having a battery release mechanism 102 is provided in an alternate exemplary embodiment of the present invention. The battery charger 100 comprises a housing 104 containing electronics and other structural elements allowing it to be used as a battery charger. The battery charger 100, as with the battery charger 10, is of a type that is typically used to charge power tool batteries, as described in more detail below with reference to the figures. However, it is reiterated that the battery release mechanisms described herein may be utilized for any battery charger that may engage with rechargeable batteries to aid in the removal of the batteries from the battery charger.

The battery charger 100 may include a battery receiving slot 106, which may comprise a pair of battery receiving slot arms 108, 110, for engaging with respective mating surfaces on a rechargeable battery 114. A set of electrical leads or contacts 112 may further be provided for engaging with respective leads or contacts on the battery 114 that may be attached thereto. When the rechargeable battery 114 slides between the battery receiving slot arms 108, 110, it may be frictionally held therein in a position and a location whereby the leads or contacts 112 of the battery charger 100 may remain engaged with the respective leads or contacts on the battery 114 disposed thereon. FIG. 8 illustrates battery 114 disposed within the battery receiving slot 106 between the battery receiving slot arms 108, 110, allowing the leads or contacts 112 of the battery charger 100 to contact the leads or contacts on the rechargeable battery 114.

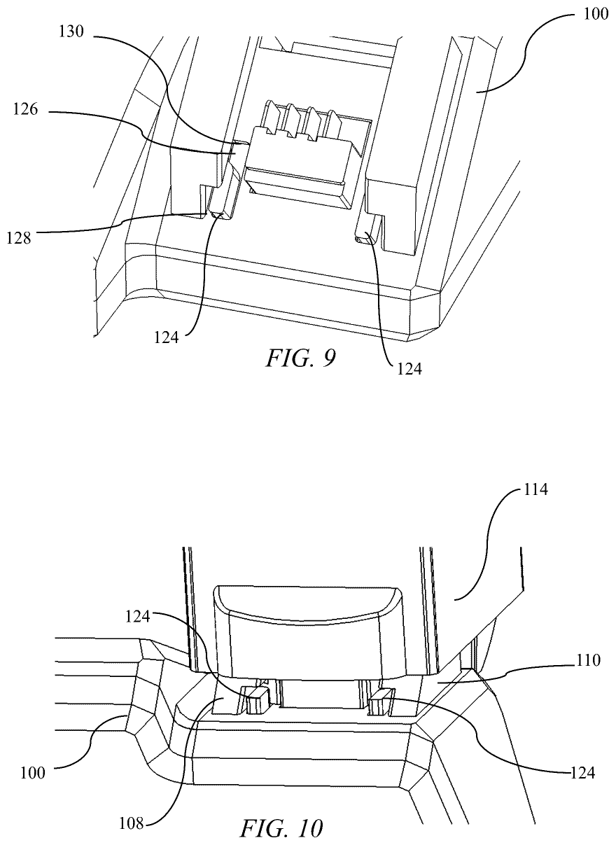

The battery release mechanism 102 may comprise a user input element, shown in figures as a pushbutton 122 upon which a user may press, as illustrated in FIGS. 8 and 9. The battery release mechanism 102 may further have one or more battery contacting elements in the form of pushers or tabs 124 that may be disposed within the battery charger 100 extending from respective slots 126. The pushers or tabs 124 may travel linearly within respective slots 126 from a first position 128 to a second position 130, as shown in FIG. 9, thereby pushing or moving the battery 114 from the battery receiving slot 106 against the friction holding the battery 114 within the battery receiving slot 106. In use, a user may push the pushbutton 122 in a first direction, namely downwardly, which may cause the pushers or tabs 124 to move in a second direction, namely upwardly, thereby pushing and moving the battery 114 at least partially from the battery receiving slot 106, as described above.

As illustrated in FIGS. 12 and 13, the pushbutton 122 may be linked to the pushers or tabs 124 via a coupling linkage in the form of a rack and pinion gear 130. Specifically, the pushbutton 122 may have a plunger 132 having a plurality of linearly disposed teeth in the form of a first rack that may engage a rotating pinion gear 134 that may rotate in a fixed or static position when engaging the teeth of the plunger 132. The pushers or tabs 124 may have an extended plate or rod 136 that may operate as a second rack, namely having a plurality of linearly disposed teeth that may contact or engage a side of the pinion gear 134 opposite the plunger 132. Thus, movement of the plunger 132 in a first direction 138, shown in FIG. 13, may cause the pinion gear 134 to rotate, thereby moving the plate or rod 126 in a second direction, thereby causing the pushers or tabs 136 to move in the second direction 140. As noted above, because the pushers or tabs 124 contact the battery 114, they may push and move the battery 114 at least partially out of the battery receiving slot 106 when the pushbutton 122 is pressed.

Specifically, when the battery 114 is desired by a user to be charged, it may be pushed within the battery receiving slot 106 of the battery charger 100, which may engage the pushers or tabs 124 thereby pushing them down. After the battery 114 has charged within the battery charger 100, a user may wish to remove the battery 114 from the battery charger 100. Pressing down on the user pushbutton 122 may cause the plunger 132 to move downwardly, moving plunger 132 relative to the pinion gear 134 causing the pinion gear 134 to rotate, thereby causing the plate or rod 136 of the pushers or tabs 124 to move linearly upwardly, pushing and forcing the battery 114 at least partially out of the battery receiving slot 106. Therefore, the battery 114 may be more easily removed from the battery receiving slot 106 and a user may accomplish the removal of the battery 114 from the battery charger 100 with one hand.

It should be noted that various changes and modifications to the presently preferred embodiments described herein will be apparent to those skilled in the art. Such changes and modifications may be made without departing from the spirit and scope of the present invention and without diminishing its attendant advantages. Further, references throughout the specification to “the invention” are nonlimiting, and it should be noted that claim limitations presented herein are not meant to describe the invention as a whole. Moreover, the invention illustratively disclosed herein suitably may be practiced in the absence of any element which is not specifically disclosed herein.

I claim:

1. A battery charger release apparatus comprising:
a battery charger comprising a battery engagement element configured to engage with and accept a battery for charging the battery when engaged thereto; and
a release mechanism on the battery charger, wherein the release mechanism comprises a user input element on a first end of the release mechanism, a battery contacting element configured to contact the battery when the battery is engaged to the battery engagement element, and a coupling linkage between the user input element and the battery contacting element, wherein the coupling linkage is configured to convert movement of the user input element to movement of the battery contacting element thereby releasing the battery from the battery engagement element.

2. The battery charger release apparatus of claim 1 wherein the release mechanism comprises a lever arm, wherein the user input element is on the first end of the lever arm and the battery contacting element is on a second end of the lever arm, and further wherein the coupling linkage comprises a pivot located between the first end and the second end of the lever arm.

3. The battery charger release apparatus of claim 2 wherein the user input element comprises a pushing surface on the first end of the lever arm.

4. The battery charger release apparatus of claim 1 wherein the battery contacting element is configured to engage a mating element on the battery.

5. The battery charger release apparatus of claim 1 wherein the battery contacting element includes a protuberance.

6. The battery charger release apparatus of claim 1 wherein the battery engagement element comprises an electrical contact or terminal.

7. The battery charger release apparatus of claim 1 wherein the battery charger comprises a cavity, wherein the release mechanism is disposed at least partially within the cavity.

8. The battery charger release apparatus of claim 1 wherein the release mechanism comprises a biasing element for biasing the user input element.

9. The battery charger release apparatus of claim 8 wherein the biasing element is a spring.

10. The battery charger release apparatus of claim 8 wherein the biasing element is configured to bias the user input element in a first direction and bias the battery contacting element in a second direction.

11. The battery charger release apparatus of claim 1 wherein the user input element comprises a push-button.

12. The battery charger release apparatus of claim 11 wherein the battery contacting element is configured to push the battery away from the battery engagement element.

13. The battery charger release apparatus of claim 12 wherein the coupling linkage comprises a plunger extending from the user input element and configured to engage the battery contacting element to cause the battery contacting element to move in a different direction as the plunger.

14. The battery charger release apparatus of claim 13 wherein the plunger is engaged to the battery contacting element through a pinion gear.

15. The battery charger release apparatus of claim 14 wherein the plunger comprises a rack having a plurality of teeth and further wherein the rack is engaged with the pinion gear.

16. The battery charger release apparatus of claim 14 wherein the battery contacting element comprises a rack having a plurality of teeth and further wherein the rack of the pusher is engaged with the pinion gear.

17. The battery charger release apparatus of claim 14 wherein the plunger comprises a first rack having a plurality of teeth, wherein the battery contacting element comprises a second rack having a plurality of teeth, and further wherein the first rack and the second rack are engaged to the pinion gear such that motion of the plunger in a first direction causes motion of the battery contacting element in a second direction.

18. The battery charger release apparatus of claim 12 further comprising a biasing element engaged with the battery contacting element.

19. The battery charger release apparatus of claim 18 wherein the biasing element is a spring.

20. The battery charger release apparatus of claim 18 wherein the biasing element is configured to bias the battery contacting element against the battery when the battery is engaged with the battery engagement element.

21. A battery charger release system comprising:
the battery charger release apparatus of claim 1; and
a battery.

22. A method of using a battery charger release system comprising the steps of:
providing a battery charger comprising a battery engagement element configured to engage with and accept a battery for charging the battery when engaged thereto and a release mechanism on the battery charger, wherein the release mechanism disengages the battery from the battery charger when manipulated by a user;
providing the battery engaged with the battery engagement element of the battery charger;
manipulating the release mechanism on the battery charger; and
disengaging the battery from the battery engagement element.

23. The method of claim 22 wherein the release mechanism comprises a user input element on a first end of the release mechanism, a battery contacting element configured to contact the battery when the battery is engaged to the battery engagement element, and a coupling linkage between the user input element and the battery contacting element, wherein the coupling linkage is configured to convert movement of the user input element to movement of the battery contacting element thereby releasing the battery from the battery engagement element.

24. The method of claim 22 wherein manipulating the release mechanism on the battery charger comprises pulling, pushing, twisting, or squeezing the release mechanism.

25. The method of claim 22 wherein movement of the release mechanism in a first direction causes the battery to disengage from the battery engagement element.
